(19) United States
(12) Patent Application Publication
(10) Pub. No.: US 2017/0303546 A1
(43) Pub. Date: Oct. 26, 2017

(54) DOUGHNUT HOLDER

(71) Applicant: William Jefferson McSorley, Glendale, MO (US)

(72) Inventor: William Jefferson McSorley, Glendale, MO (US)

(21) Appl. No.: 15/136,922

(22) Filed: Apr. 23, 2016

(51) Int. Cl. A21C 15/00; A47J 43/00

(52) U.S. Cl. CPC A21C 15/00; A47J 43/00

(57) ABSTRACT

The doughnut holder is a single molded plastic device that has an elongated cup shape at the top and a shaft shaped base that extending down from the cup. The walls of the cup shape have open sides on the elongated ends and a small flap in what is the front of the cup and a larger flap in the back of the cup, that provides an open top of the cup shape, in which a single doughnut can be partially inserted, for holding the doughnut in an upright position. The design and shape of the doughnut holder allows the front surface of the doughnut to be viewed in an upright position. The doughnut holder can be used by itself or with multiple doughnut holders to make a display or arrangement for sale or marketing purposes.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

### APPENDIX

Not Applicable

### BACKGROUND OF THE INVENTION

For the commercial sale and marketing of gourmet, decorated, or traditional doughnuts, there are limited ways to present them for display and merchandising. It is important to see the front surface of the doughnut. Especially if it is a decorated doughnut. Seeing the front surface of many types of doughnuts is also relevant for visually identifying ingredients and for its visual appeal to a persons' apatite. Seeing the front of the doughnut is also important in the selling and merchandising of any doughnut that is not recognized by a trade name.

For the sale and marketing of gourmet, decorative, traditional, or commercially-made doughnuts, there are limited methods of displaying them individually, in an arrangement, or on display that show the front of the doughnut.

Specifically, there are limited ways to present doughnut in an upright position and show the front of the doughnut. An existing method is to place them in a box or carton that has a clear top and position the box at an upright angle. Another method is laying the doughnuts on a display tray, and angling the tray so the top of the doughnut can be seen. But the doughnut would have to be removed from the display tray for sale.

These methods limit the ability to sell a group of doughnuts as a display or arrangement.

### BRIEF SUMMARY OF THE INVENTION

The doughnut holder is a single molded plastic device that has an elongated cup shape at the top and a shaft shaped base that extending down from the cup. The walls of the cup shape have open sides on the elongated ends and a small flap in what is the front of the cup and a larger flap in the back of the cup. This design provides an open top of the cup shape, in which a doughnut can be partially inserted, for holding a doughnut in an upright position.

The doughnut holder is designed to hold any type of traditional doughnut, regardless of ingredients, in an upright position, that allows the majority of the front surface of the doughnut to be viewed. The doughnut holder is designed to hold a single doughnut, by placing the lower portion of the doughnut's edge within the base of the cup, between the front and back flap of the cup.

The doughnut holder provides a method of displaying any single doughnut by itself, or when multiple doughnut holders are used together in upright positions, they can be used to make an arrangement or display. This method would allow the observation of the doughnut's front surfaces, to view decorated surface(s) or ingredient(s) of the doughnut.

The doughnut holder expands the ability to market and sell any type of doughnut individually, in arrangements, and gift displays.

### BRIEF DESCRIPTION OF THE SEVERAL VIEWS OF THE DRAWING

FIG. 1 is a perspective view of a doughnut holder with broken line of a doughnut to show usage;

FIG. 2 is a front elevational view of FIG. 1;

FIG. 3 is a back elevational view of FIG. 1;

FIG. 4 is a left elevational view of FIG. 1;

FIG. 5 is a right elevational view of FIG. 1;

FIG. 6 is a top plan view view of FIG. 1;

FIG. 7 is a bottom plan view of FIG. 1;

FIG. 8 is a perspective close up view of the notches on the back side of the shaft of FIG. 1; and

FIG. 9 is an example of a perspective view of multiple doughnut holders used in arrangement thereof.

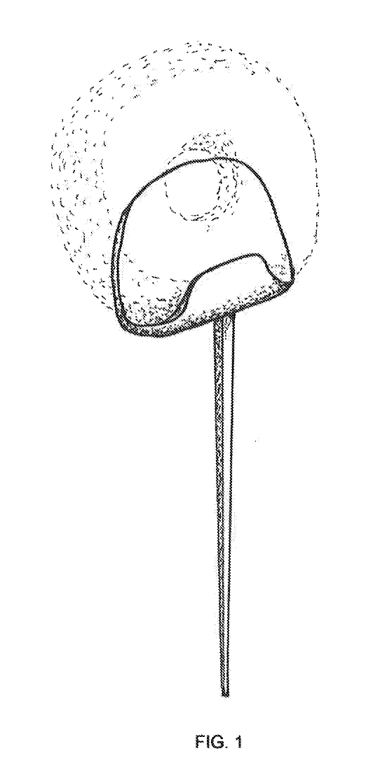

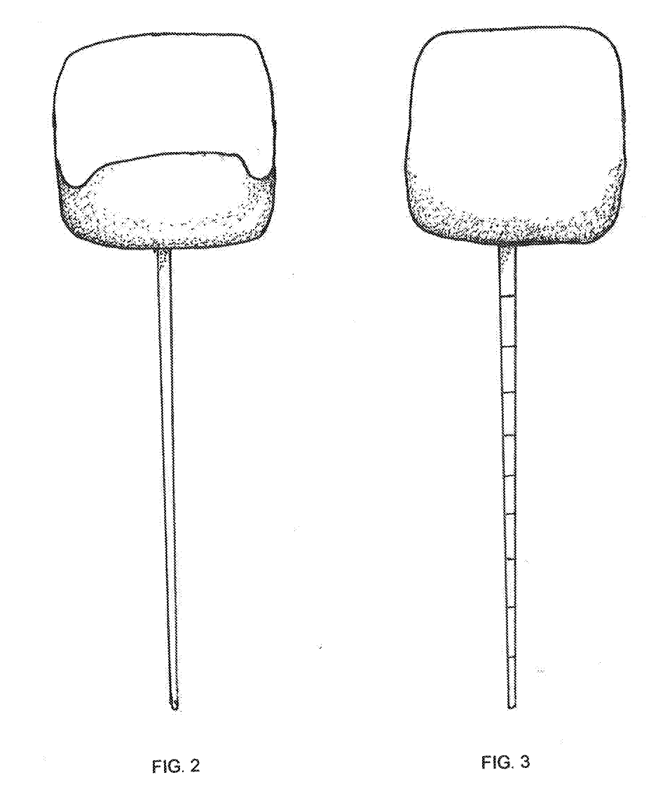

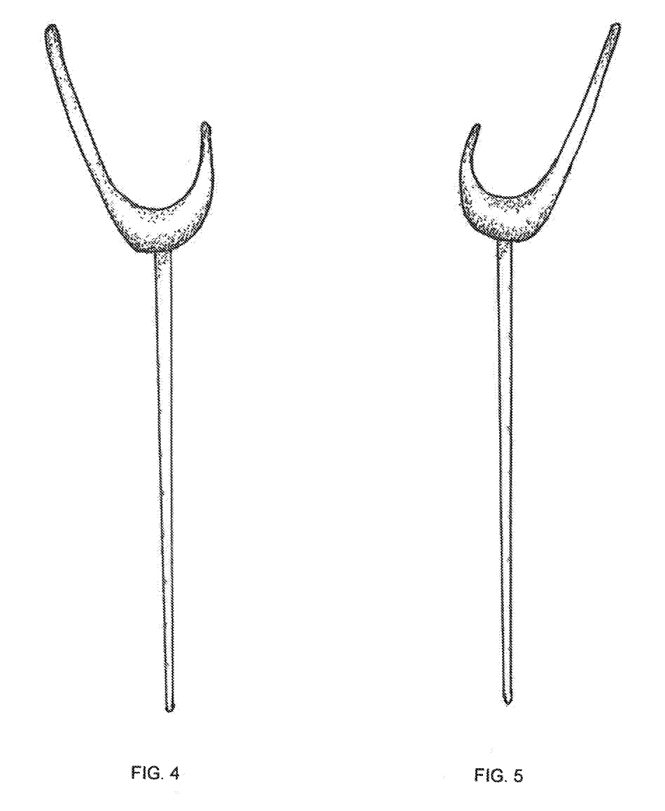

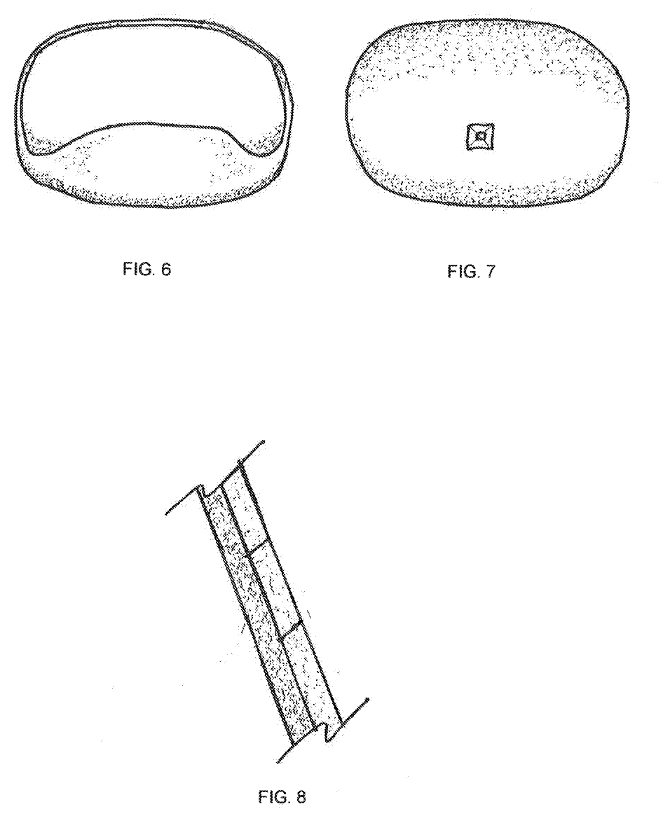

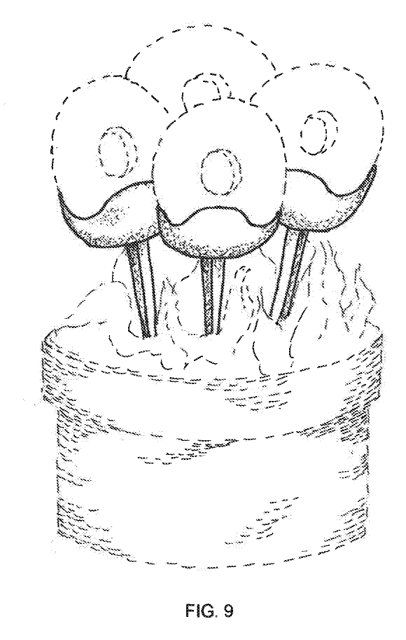

### DETAILED DESCRIPTION OF THE INVENTION

The doughnut holder is a single molded piece of plastic that has a cup shape at the top and a shaft extending down from the cup. The doughnut holder will be made in an injected mold process. The plastic used is a “food-safe” plastic. The doughnut holder can be made in a variety of colored plastics. The variety of colors will allow coordinating the colored doughnut holder(s) for use with various holidays, themed events, and occasions. In example: Orange and/or Black for Halloween. Red, White, and Blue for the 4^{th} of Jul.

The overall height of the doughnut holder is 12 inches from top to bottom.

The form of the cup area has rounded surfaces and oval shapes in its design. The cup section of the doughnut holder is 3 inches across in width. The back flap section is 2½ inches high from the base of the cup to its top edge. The back flap section is 0.125 inches thick. The front flap is 1 inch high from the base of the cup to its top edge. The front flap is 0.125 inches thick at the bottom to 0.0625 inches thick at the top of the flap. The depth of the cup is 1.75 inch from the front surface of the cup to the back surface of the cup. The front and back flap sections are each 0.125 inches at their thickest depth. This provides a 1.50 inch space between the front and back flaps for inserting a doughnut.

From the straight up vertical stem, the cup area of the doughnut holder is angled back, at a 20 degree angle. This angle helps surface ingredients stay or lay on the front surface of the doughnut. In example: icing and/or edible decorations.

The shaft part of the doughnut holder is centered on the bottom of the cup and extends down 9½ inches long. It is square in shape with one of the flat surfaces to the front of the doughnut holder. The top section of the shaft closest to the cup is 0.25 inches square in shape and tappers to 0.125 inch square in shape at the bottom.

The shaft of the doughnut holder can be cut to various lengths for providing different heights in an arrangement or display. The back side of the shaft has horizontal notches on the flat surface spaced every 1 inch from the top of the shaft to the bottom of the shaft. These notches are 0.03125 deep into back surface of the shaft. These are used as guides for cutting the shaft.

For use of the doughnut holder, take a single doughnut, and insert an edge of the doughnut into the top open cup area of the doughnut holder, between the front flap and the back flap. Press the doughnut down into the doughnut holder until it reaches the bottom of the cup area or is secure enough to hold in place. This can be done directly into the doughnut holder (food-safe plastic). An alternative method, the doughnut could be partially wrapped on the bottom edge with a food-safe tissue before inserting into the doughnut holder. This can be done for a decorative effect.

The doughnut holder's shaft portion can be inserted into materials to hold it in place in an upright position. In example, the shaft can be inserted into Styrofoam. The square edges of the shaft prevent the doughnut holder from rotating or twisting when inserted into firm materials. The doughnut holder can be used with other doughnut holders to make an arrangement or display.

Example to make a doughnut arrangement. A bowl, pot, or basket, carp used as a base container. A piece of Styrofoam can be placed in the container. The shafts of the doughnut holders can be inserted into the Styrofoam in an upright arrangement. Doughnuts can then be inserted into the doughnut holders, Food-safe tissue or other decorative materials can be added around the base of the doughnut holders shafts for a decorative effect.

What is claimed is:

1. The doughnut holder is a device comprising of a single molded piece of plastic that has an elongated cup shape at the top and a shaft shaped base that extending down from the cup.

2. The doughnut holder of claim 1, wherein will be made in an injected mold process.

3. The doughnut holder of claim 1, wherein the plastic used to make the devise is a food-safe plastic.

4. The doughnut holder of claim 1, wherein can be made in a variety of colored plastics.

5. The doughnut holder of claim 4, wherein the variety of colors will allow coordinating the colored doughnut holder(s) for use with various holidays, themed events, and occasions.

6. The doughnut holder of claim 5, wherein example: Orange and/or Black for Halloween or Red, White, and Blue for the 4^{th} of Jul.

7. The doughnut holder of claim 1, wherein has an overall height of 12 inches from top to bottom.

8. The doughnut holder of claim 1, wherein the cup area has the form of rounded surfaces and oval shapes in its design.

9. The doughnut holder of claim 8, wherein the cup section of the doughnut holder is 3 inches across in width.

10. The doughnut holder of claim 8, wherein the back flap section is 2½ inches high from the base of the cup to its top edge.

11. The doughnut holder of claim 8, wherein the back flap section is 0.125 inches thick.

12. The doughnut holder of claim 8, wherein the front flap is 1 inch high from the base of the cup to its top edge.

13. The doughnut holder of claim 8, wherein the front flap is 0.125 inches thick at the bottom to 0.0625 inches thick at the top of the flap.

14. The doughnut holder of claim 8, wherein the depth of the cup is 1.75 inch from the front surface of the cup to the back surface of the cup.

15. The doughnut holder of claim 8, wherein the front and back flap sections are each 0.125 inches at their thickest depth.

16. The doughnut holder of claim 15, wherein this provides a 1.50 inch space between the front and back flaps for inserting a doughnut.

17. The doughnut holder of claim 8, wherein from the straight up vertical stem, the cup area of the doughnut holder is angled back, at a 20 degree angle.

18. The doughnut holder of claim 17, wherein this angle helps surface ingredients stay or lay on the front surface of the doughnut.

19. The doughnut holder of claim 17, wherein in example: icing and/or edible decorations.

20. The doughnut holder of claim 1, wherein the shaft portion of the doughnut holder is centered on the bottom of the cup and extends down 9½ inches long.

21. The doughnut holder of claim 20, wherein it is square in shape with one of the flat surfaces to the front of the doughnut holder.

22. The doughnut holder of claim 20, wherein the top section of the shaft closest to the cup is 0.25 inches square in shape and tappers to 0.125 inch square in shape at the bottom.

23. The doughnut holder of claim 20, wherein the shaft of the doughnut holder can be cut to various lengths for providing different heights in an arrangement or display.

24. The doughnut holder of claim 20, wherein the back side of the shaft has horizontal notches on the flat surface ever spaced every 1 inch from the top of the shaft to the bottom of the shaft.

25. The doughnut holder of claim 20, wherein these notches are 0.03125 deep into back surface of the shaft.

26. The doughnut holder of claim 20, wherein these are used as guides for cutting the shaft at specific lengths.

27. The doughnut holder of claim 1, wherein for the use of the doughnut holder, take a single doughnut, and insert an edge of the doughnut into the top open “cup” area of the doughnut holder, between the front flap and the back flap.

28. The doughnut holder of claim 27, wherein insert the doughnut down into the doughnut holder until it reaches the bottom of the cup area or is secure enough to hold in place.

29. The doughnut holder of claim 27, wherein this can be done directly into the doughnut holder (food-safe plastic).

30. The doughnut holder of claim 27, wherein an alternative method, the doughnut could be partially wrapped on the bottom edge with a food-safe tissue before inserting in to the doughnut holder. This can be done for a decorative effect.

31. The doughnut holder of claim 1, wherein the doughnut holder's shaft portion can be inserted into materials to hold it in place in an upright position.

32. The doughnut holder of claim 31, wherein example, the shaft can be inserted into Styrofoam.

33. The doughnut holder of claim 31, wherein the square edges of the shaft prevent the doughnut holder from rotating or twisting when inserted into firm materials.

34. The doughnut holder of claim 31, wherein the doughnut holder can be used with other doughnut holders to make an arrangement or display.

35. The doughnut holder of claim 1, wherein an example to make a doughnut arrangement.

36. The doughnut holder of claim 35, wherein a bowl, pot, or basket, can used as a base container.

37. The doughnut holder of claim 35, wherein a piece of Styrofoam can be placed in the container.

38. The doughnut holder of claim 35, wherein the shafts of the doughnut holders can be inserted into the Styrofoam in an upright arrangement.

39. The doughnut holder of claim 35, wherein doughnuts can then be inserted into the doughnut holders.

40. The doughnut holder of claim 35, wherein food-safe tissue or other decorative materials can be added around the base of the doughnut holders shafts for a decorative effect.
